(19) United States
(12) Patent Application Publication
(10) Pub. No.: US 2014/0279875 A1
(43) Pub. Date: Sep. 18, 2014

(54) METHOD AND APPARATUS FOR CONVERTING DATA

(71) Applicant: Matthew Pitstick, San Carlos, CA (US)

(72) Inventor: Matthew Pitstick, San Carlos, CA (US)

(21) Appl. No.: 13/843,243

(22) Filed: Mar. 15, 2013

(51) Int. Cl. G06F 17/30

(52) U.S. Cl. CPC G06F 17/30575
USPC 707/610

(57) ABSTRACT

The present invention comprises a method and apparatus for converting data from project scheduling tools into UN/CEFACT XML, compiling the UN/CEFACT XML data into a database, and analyzing the project scheduling data from multiple project scheduling tools. The present invention relates to normalizing digital project management data, and more particularly, to a method and apparatus for converting data from multiple project scheduling tools into the UN/CEFACT Electronic Data Interchange (EDI) Extensible Markup Language (XML) schema. Additionally, the invention comprises a method for importing the UN/CEFACT XML data into a relational database in which various forms of analysis are performed.

### TECHNICAL FIELD

The present invention comprises a method and apparatus for converting data from project scheduling tools into UN/CEFACT xml, compiling the UN/CEFACT xml data into a database, and analyzing the project scheduling data from multiple project scheduling tools. The present invention relates to normalizing digital project management data, and more particularly to a method and apparatus for converting data from multiple project scheduling tools into the UN/CEFACT Electronic Data Interchange (EDI) Extensible Markup Language (XML) schema. Additionally, the invention allows the import of data from the UN/CEFACT XML standard into a relational database in which various forms of analysis are performed.

### BACKGROUND ART

Many project scheduling software programs exist in the prior art. Project scheduling programs offer a variety of different tools in order to develop an appropriate schedule for a project. The programs aid users in the following ways, including, but not limited to: monitoring and controlling project activities; determining how to allocate resources; determining how time delays will affect the project; determining where excess resources in the project exist; determining the longest path of the networked schedule, which uses the Critical Patch Methodology (CPM); and a way to more easily track projected progress. Importantly, project scheduling programs offer a way in which users improve the management process in a project while streamlining the management reviews.

Extensible Markup Language (XML) is a markup language for encoding documents in a format that is both human-readable and machine-readable. XML is commonly used for structuring documents for transmission via the World Wide Web (WWW). XML allows for adaptability of such documents through a set of XML grammar rules.

The United Nations Centre for Trade Facilitation and Electronic Business (UN/CEFACT) is an organization that is responsible for making international Electronic Data Interchange (EDI) standards for electronic trade documents in XML format. As a result of having multiple XML schema languages available, UN/CEFACT adopted UN/CEFACT XML as the data exchange standard schema for project management reporting.

UN/CEFACT XML has been established as the means of submitting project performance data for new defense contracts by Performance Assessments and Root Cause Analyses (PARCA), a Directorate of the Office of the Assistant Secretary of Defense for Acquisition. This is after the National Defense Industrial Association's Program Management Systems Committee (NDIA PMSC) worked in cooperation with major government contractors and agencies in the U.S. Department of Defense (DoD) to determine the feasibility of issuing an XML standard for project schedule data. This standard was officially adopted by PARCA who officially published a policy letter establishing the new XML as the means of submitting project performance data for new defense contracts.

The UN/CEFACT XML Naming and Design Rules specification defines an architecture and set of rules necessary to define, describe, and use XML to consistently express business information exchanges. It is based on the World Wide Web consortium (W3C) suite of XML specifications and the UN/CEFACT Core Components Technical Specification. This specification is used by UN/CEFACT to define XML Schema and XML Schema documents which are published as UN/CEFACT standards. It is also used by other Standards Development Organizations who are interested in maximizing inter- and intra-industry interoperability.

Before UN/CEFACT XML was established as the means of submitting project performance data for new defense contracts, the DoD relied on a series of proprietary files in order to perform its oversight responsibility in ensuring that public projects were performing as contractually required. As part of the reinventing government initiative under the Clinton Administration, private industry took ownership of developing project management best business practices such as earned value management (EVM) and project schedule management. Thus, standardized metrics and measures of success were identified across governmental, organizational, and corporate cultures.

Initially DoD developed and issued an Electronic Data Interchange (EDI) standard for EVM in the ANSI X12 839 transaction set, but when a similar attempt was made to normalize schedule planning and execution information across disparate proprietary software applications (using the ANSI X12 806 transaction set), no agreement was reached. Interim attempts since 1997 were met both by industry skepticism and resistance from software vendors. That is, until PARCA officially published a policy letter establishing the new XML as the means of submitting project performance data for new defense contracts.

Project scheduling programs are especially important for government contractors who must meet strict government mandated reporting requirements, including the reporting of EVM, risk, and financial information. EVM is an objective manner to measure project performance that combines measurements of scope, schedule, and cost into a single integrated system. Thus, EVM is able to provide accurate forecasts of project performance problems.

All data must be reported to the DoD in UN/CEFACT XML so that the DoD can perform analytics on the project. Each project has any number of subcontractors working on it, all of which may have used different proprietary project scheduling software applications. Once the data is reported to the DoD in UN/CEFACT XML, the DoD determines items such as overall budget, time constraints, why projects are falling behind, and why projects are costing more money.

The Defense Contract Management Agency (DCMA) is the agency of the United States federal government that performs contract administration for certain federal agencies, including the DoD. The DCMA uses a 14 Point Assessment to assess schedule quality, and that, when met, ensure a well-planned project in terms of schedule integrity and construction. The 14 factors it analyzes are: logic, leads, lags, finish to start relations, hard constraints, high float, negative float, high duration, invalid dates, resources, missed activities, critical path test, calculation of the critical patch length index, and baseline execution index. Analyzing these 14 factors are key in determining whether a project is scheduled properly and how well the project is executing to the baseline plan.

Due to the relatively large number of project scheduling programs on the market, problems arise when trying to transfer data across different programs. In large projects, it is common for different groups that are working on the same overall project to be using different proprietary project scheduling programs. This occurs frequently when contractors have subcontractors and partners that use different programs. This makes it difficult and cumbersome for project managers to analyze data in large projects due to the multiple programs being used since each program tends to store its data differently, with different functionality, algorithms, and nomenclature.

The apparatus of the present invention eliminates proprietary barriers to integrated project visibility by leveraging both the industry UN/CEFACT XML standard for cost, schedule, and financial management information, as well as its own unique capabilities for integrating business enterprise data regardless of the underlying database.

The apparatus of the present invention provides the ability to normalize data across multiple proprietary cost, schedule, and financial applications, thus supporting the standard terminology of the professional disciplines and professions that underlie project management, facilitating communication, reducing both direct and indirect costs associated with acquisition, training, and maintenance of multiple proprietary applications, and facilitating the objective assessment of project performance, particularly for agencies and organizations acting in the public interest in assessing project performance, by breaking down proprietary terminology and nomenclature that obfuscates the commonalities in the underlying concepts and data.

The apparatus of the present invention provides an on-the-fly virtual program review in an interactive environment that allows analysts and management to identify challenges quickly and decisively regardless of the source of the information and across project disciplines.

The apparatus of the present invention allows for a project manager who is managing multiple subcontractors as well as other project stakeholders to determine the status of a project, as well as metrics such as who is behind schedule and who is over budget. On any given project, there is any number of subcontractors working on it. Presently, project managers managing multiple subcontractors are not able to easily and directly compare and integrate data from one project scheduling program to data from a different project scheduling program. Analytics currently have to be run on each project scheduling data and then compared in order to determine whether the project was on schedule, under budget, etc. The apparatus of the current invention provides a single program whereby data from multiple project scheduling programs is uploaded to the program, converted to UN/CEFACT XML, imported into the database, and analytics are run across the data compiled from the multiple project scheduling tools. Thus, data from one project scheduling program is directly compared to data from a different project scheduling program all in one program to manage the dependencies and risks or opportunities that may exist to the project.

Each stakeholder in a project management organization has its own specific role and need for information. The apparatus of the present invention provides specific users or groups of users with only that information that they need to view in the format required by their business.

The apparatus of the present invention assists in saving time in training new personnel. The focus is shifted to the information, where it belongs, instead of on the time-consuming task of running analytics on data from multiple project scheduling programs before the data is compared. This contributes to the project team's productivity and effectiveness.

The apparatus of the present invention provides analytics once the data is converted to UN/CEFACT XML and imported into the database. The analytics include the DCMA 14 Point Assessment, as well as metrics, views, and other outputs that were custom built to support the industry best practices of analyzing and reporting on this type of project management data, as well as other metrics and visuals that transform the data into useful and meaningful information that is easy to communicate to project stakeholders regarding the health and status of the project. Visual objects such as grids, graphs, reports, pivots, Gantt charts, histograms, completion reports, and alerts are also obtained.

The apparatus of the present invention provides unparalleled real-time integrated project management, assessment, and reporting capabilities which supports dynamic project management environments. The apparatus of the present invention further breaks down organizational and proprietary barriers to support the effective use of essential project management information needed to empower project personnel in making decisions essential to project success.

The apparatus of the present invention eliminates the need for summary level data mapping and personnel intervention in order to achieve integration by providing a single program that converts data from multiple project scheduling tools into UN/CEFACT XML, imports the UN/CEFACT XML data into a database, and runs analytics on the data across multiple data sets from, typically, different contractors all working on a single project.

The apparatus of the present invention allows for visibility of relevant data that in the past had been unavailable due to the limitations imposed by solutions contained in the prior art. For example, limitations in Oracle Primavera P6 do not allow for time-phasing of schedule performance data and many scheduling programs do not store historical data through the life of the project. Thus, the apparatus of the present invention provides this important functionality.

There currently are no systems currently available that are able to analyze data over multiple project scheduling programs. Additionally, there are no systems currently available that transform data from multiple project scheduling programs into UN/CEFACT XML. Prior art does exist that transforms data between schemas using different methods.

U.S. Pat. No. 8,032,828 B2 discloses a method and system of document transformation between a source XML schema and a target XML schema. This prior art only transforms a source XML schema to a target XML schema. Additionally, the target XML schema is mapped.

U.S. Pat. No. 2006/0218158 A1 discloses translation of information between schemas. This prior art uses an intermediary schema whereby it converts a first schema to an intermediary schema before translating it to a secondary schema.

U.S. Pat. No. 8,041,746 B2 discloses mapping schemas using a naming rule. This prior art also uses an intermediary schema before translating the data into the target schema.

U.S. Pat. No. 2010/0083084 A1 discloses creating electronic data interchange relationships. This prior art creates a data structure for the interchange of data.

U.S. Pat. No. 7,886,225 B2 discloses a method and apparatus for the creation, location, and formatting of digital content. This prior art translates a first schema into a second schema using a computer-implemented ontology, whereby, the first schema is translated into an intermediary schema before being translated into the secondary schema.

U.S. Pat. No. 6,829,745 discloses a method and system for transforming an XML document to at least one XML document structured according to a subset of a set of XML grammar rules. This prior art combines multiple XML files into a single XML file.

An advantage of the apparatus of the present invention is that it allows for data from multiple project scheduling systems to be analyzed quickly and easily, all from one graphical user interface.

Another advantage of the apparatus of the present invention is that it is able to perform analytics that are commonly used to analyze how projects are performing.

Certain metrics are commonly used to analyze how projects are performing. The S-curve is a commonly used model for observing a project from start to finish. Generally, items such as costs and labor hours are plotted against time. This is used to predict planned value, earned value, actual cost and estimate to complete of the project. Typically, costs are very high initially in a project with small performance improvements, but as time goes on, small costs result in higher performance improvements.

The 14 Point Assessment used by the DCMA is another commonly used metric to assess schedule quality. Visual objects such as grids, graphs, reports, pivots, Gantt charts, histograms, completion reports, and alerts are all commonly used to review the performance of projects. The apparatus of the present invention automatically runs this assessment regardless of the underlying proprietary scheduling software application.

The apparatus of the present invention, as a result of its unique integration and normalization capabilities, allows the introduction of new and unique leading-edge indicators in the assessment of project performance management that changes the paradigm of the project management discipline that has depended traditionally on trailing-edge indicators.

Certain embodiments of the invention comprise a plurality of steps or elements in addition to or in place of those mentioned above. The steps or element will become apparent to those skilled in the art from a reading of the following detailed description when taken with reference to the accompanying figures.

### SUMMARY OF THE INVENTION

The present invention comprises an apparatus that converts data from multiple project management software into UN/CEFACT XML. The present invention also comprises an apparatus that transfers the UN/CEFACT XML data into a database, whereby procedures are automatically run to normalize the data and generate a valid replication of the schedule data in a normalized state. The present invention also comprises an apparatus that analyzes the UN/CEFACT XML data obtained from multiple project scheduling systems whereby the data from each multiple project scheduling system is compared directly to data from other multiple project scheduling systems.

The present invention also comprises a method of analyzing and managing project schedule performances over multiple project scheduling systems across multiple periods of performance to highlight trending and changes in the schedule over time.

The present invention comprises a method for analyzing data comprising converting project scheduling data to UN/CEFACT XML; importing the UN/CEFACT XML data into a database; normalizing the data; generating a valid replication of the schedule data in a normalized state; and calculating metrics.

The present invention further comprises a method for analyzing data comprising converting proprietary project scheduling data to UN/CEFACT XML; drawing data contained in multiple UN/CEFACT XML data files contained in the database; containing other UN/CEFACT XML data obtained by transforming data from other project scheduling software; modeling project scheduling data from proprietary project scheduling software; directly converting the data by direct field mapping into UN/CEFACT XML; calculating user-defined metrics; and calculating pre-determined metrics.

### BRIEF DESCRIPTION OF THE DRAWINGS

FIG. 1 is a flow chart illustrating a process of transforming project source data into standard UN/CEFACT XML format file, importing the data into the database, and running analytics on the data contained in the database;

FIG. 2 is a flow chart illustrating a process of transforming a source Microsoft Project file to standard UN/CEFACT XML format file;

FIG. 3 is a flow chart illustrating a process of transforming Oracle Primavera P6 or Deltek Open Plan Professional project data to standard UN/CEFACT XML format file;

FIG. 4 is a flow chart illustrating a process of transforming project source data from a legacy or uncommonly used scheduling program to standard UN/CEFACT XML format file via the means of a Microsoft Excel template;

FIG. 5 is a flow chart illustrating a process of importing standard UN/CEFACT XML format file, or other XML schema type file, into the database, normalizing the data, generating a valid replication of the schedule data in a normalized state, and associating the data with a specific project if the project currently exists in the database, or otherwise creating a new project; and

FIG. 6 is a flow chart illustrating a process of running analytics on a project containing standard UN/CEFACT XML format file(s), or other XML schema type file.

### DETAILED DESCRIPTION OF THE INVENTION

The best mode for carrying out the invention will be described herein. The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known system configurations, and process steps are not disclosed in detail.

The figures illustrating embodiments of the system are semi-diagrammatic and not to scale and, particularly, some of the dimensions are for the clarity of presentation and are shown exaggerated in the drawing figures.

The same numbers are used in all the drawing figures to relate to the same elements. The embodiments have been numbered first embodiment, second embodiment, etc. as a matter of descriptive convenience and are not intended to have any other significance or provide limitations for the present invention.

The apparatus of the present invention comprises a method for taking data from proprietary project scheduling programs and converting the data into UN/CEFACT XML. Direct field maps are used in order to convert the data from the project scheduling programs into UN/CEFACT XML. The data from the project scheduling programs is not dynamic. This is especially true for project scheduling programs such as Microsoft Project. For project scheduling tools such as Oracle Primavera and Deltek Open Plan Professional, the apparatus of the present invention directly accesses the database or the transfer file from the project scheduling program. In the case of a legacy or uncommonly used scheduling program, the apparatus of the present invention comprises a Microsoft Excel template that the data from the source program is entered or mapped to. Once contained in the template, the apparatus of the present invention is executed to create the UN/CEFACT XML from the template data.

Through the apparatus of the present invention, there is an expected standardized structure in the source file that comprises certain fields, attributes, elements, and content. In the apparatus of the present invention, the information within these fields are directly mapped to the appropriate locations in the destination UN/CEFACT XML output file without any intermediary transform, translation, or mapping files.

When converting the project scheduling data, the user enters custom information using the graphical user interface (GUI) that is not included in the original source project scheduling data. The UN/CEFACT XML comprises fields in its schema that need to be populated for compliance to the needs of the project management profession that are not contained within the source scheduling programs. An example of an extra field that is not included in source project scheduling data would be “Contract Number.” Thus, the GUI allows for this field to be entered in and appropriately mapped to the UN/CEFACT XML element. The GUI also allows for easy interaction with the program by the user.

When importing the UN/CEFACT XML file into the database of the present invention, the user selects the schema type. Under the UN/CEFACT XML standard, there are 3 standard schemas within that UN/CEFACT “umbrella.” The three schemas are: cost schema, schedule schema, and historical and time phased cost. These schemas support the data exchange for what government contractors need to provide to the government every week or month under the Integrated Program Management Reporting (IPMR) Data Item Deliverables (DiD), which comprises Formats 1-7. Formats 1-5 are typically formal reports on cost and performance of the contract where the UN/CEFACT puts those reports into data and these tie to the Formats 1-5 and the cost schema XML. The Format 6 is for deliverable of the Integrated Master Schedule (IMS) in UN/CEFACT form as well as the source scheduling application native file, which is tied to the schedule schema XML. The Format 7 is tied to the historical and time phased cost schema and is purely a data transfer, which is collection of all the history of primarily the Format 1 and Format 2 and future period budgets and estimates. The three schemas share a lot of elements between them, defined by the UN/CEFACT standard. They are broken out separately to consolidate the files. The various formats typically come from different types of applications like a scheduling tool and earned value engine.

Once the files are converted to UN/CEFACT XML, they are imported into the database of the present invention using an import tool that is part of the present invention. The database is a full relational database whereby the data is organized in such a way that it is accessed easily and quickly by the program. The database comprises: tables with relational database management system (RDBMS) rules and relationships on those tables; various fields within each table specifying field rules and data types; indexes on tables to improve database performance; and procedures to perform calculations, aggregations, and metrics from the industry standard base elements.

After the UN/CEFACT XML is imported into the database of the present invention, procedures within the database are automatically called to perform calculations on that newly imported data. Depending on the imported schema (i.e., cost, schedule, or historical time phased), various procedures are implemented to perform the necessary calculations. Procedures are run to normalize the data and generate a valid replication of the schedule data in a normalized state.

When cost data is imported, procedures contained in the present invention perform calculations to: 1) aggregate cost data up the Work Breakdown and Organization Breakdown structures since the data in the UN/CEFACT XML for cost is only at the lowest level of those structures; 2) calculate current period cost values by subtracting the latest period's inception to date cost and performance minus the last periods inception to date cost and performance; and 3) derive various metrics and analytical fields now that core data is at every level for cumulative and current period. This is similar when the historical time phased schema is imported since that UN/CEFACT XML file will have all reporting periods included in it opposed to the normal incremental reporting period carried out by just the cost schema.

When schedule data is imported, the database of the present invention performs calculations: 1) to normalize certain fields so they are used more appropriately in analysis, such as normalizing all duration fields into common denominator like days or hours, since the UN/CEFACT schema allows for durations to be a text field with a number and time unit for each activity. For instance, if Activity A in UN/CEFACT XML has duration of 8 hours and Activity B has duration of 2 days, then calculations will add a field called DurationDays that comprise a value of 1 for Activity A and 2 for Activity B; 2) on schedule perform delta calculations to the last schedule import used in schedule trending and change management; and 3) to derive new metrics and group similar activities together by various attributes (milestones vs activities vs summaries and critical activities and activities that comprise float within various ranges, etc.).

The apparatus of the present invention provides analytics of the data stored in the database. Structured Query Language (SQL) statements are included that retrieve and calculate underlying data from the database. SQL is a special-purpose programming language that was designed for managing data held in a Relational Database Management System (RDBMS).

While analytics are automatically run on the user selected data, the GUI allows the user to select other analytics to run on the data.

The user starts by selecting a file in the GUI to transform into UN/CEFACT XML. Once the file is transformed into a UN/CEFACT XML file, the file is imported into the database of the present invention using an import tool within the present invention. There is a separate database, or a common database, for each project, i.e., all transformed UN/CEFACT XML files from subcontractors working on a certain project would all be contained in one database or all projects of an organization are stored in a common database facilitating portfolio analysis and reporting.

In one embodiment of the present invention, there is one common database for all project files.

Once the data from the UN/CEFACT XML file or files are in the database, the user, through the GUI, runs analytics on the data or a project. The apparatus of the present invention comprises standard workspaces whereby the user chooses which sets of UN/CEFACT XML files they would like to run analytics on and, depending on the workspace selected, the analytics are automatically run and certain reports generated. The outputs from the project are tailored for project management needs. However, the user also chooses other analytics to run on the data.

The workspaces are pre-configured, are discretely selected or restricted, and are customized by the user or the administrator as necessary.

The analytics of the database provides certain pre-programmed, proprietary workspaces that automatically provide certain analysis. These workspaces were created using commonly used best of breed metrics and industry specific metrics in project scheduling, as well as innovative metrics from experience in the field. The different workspaces are: network schedule; cost data select; cost data; 14 point assessment; and variance analysis.

The network schedule workspace allows users to perform analysis on the schedule, which includes reporting on total float, durations, dates, delays, variances, codes, relationships, calendars, and resource assignments. Charts and analytical reports are also included in this database to show trending of the schedule and underlying activities. Total float refers to the amount of time that a task in the project is delayed without causing delay to the project completion date.

The cost data select workspace allows users to perform earned value analysis on a project through the selected work breakdown structure (WBS) or organizational breakdown structure (OBS), as well as individual organizational units. WBS is a project management technique that breaks a project down into smaller components, while OBS creates a hierarchy of all organizations working on a particular project and specifies data for each organization, specifically, allocated cost and who approves that organization's work. Charts and analytical reports are also included in this database to show trending of the schedule and underlying activities. This workspace also integrates cost and schedule fields together based on common WBS Rosetta Stone allowing the user to see the cross-discipline interdependencies.

The cost data workspace allows users to see portfolio analysis of earned value metrics across a project. This workspace also comprises the ability to run contract performance reports and view the data in tailorable dashboard views

The 14 point assessment workspace runs the 14 assessment checks defined by the DCMA which calculates the health of the metric against industry benchmarks and shows the details of what activities have tripped the metric.

The variance analysis workspace allows users to perform analysis of elements of the project and write Format 5 narratives for those elements that have breached thresholds as defined in the program. The Cost Performance Report (CPR) Format 5 provides narrative explanation of cost, schedule, and other problems related to total contract, undistributed budget (UB), management reserve (MR), performance measurement baseline (PMB), and manpower. The variance reporting thresholds are set by the user usually based on an agreement by project stakeholders through the project contractual terms and conditions, or by either corporate, project, or local business rules. Explanations, and thus problem analysis reporting, is only required for those variances that breech the established threshold(s). The report will identify those variances that breach the established thresholds and provide a workspace for the analyst to provide necessary information to identify the cause and corrective action of the threshold breach.

User inputs his or her own fields in any of the pre-programmed workspaces, or the user creates a custom workspace and specifies fields and outputs. All workspaces are saved for later access and rollout to user community.

The introduction of new leading-edge indicators provides insight into project performance not previously available. The ability to integrate cost, schedule, and financial information relating to project performance regardless of the underlying application and aggregated as necessary at the appropriate level of management provides insights into project performance not previously available in an industry that has depended on backward-looking, performance-to-date trailing-edge indicators that are limited in their ability to project the probability of future project performance and outcomes.

The apparatus of the present invention provides leading-edge indicators, as opposed to trailing-edge indicators, that result from integration. In the past time-phase cost data is looked at separately from time-phase schedule at different levels. The present invention allows for comparison at the appropriate level in virtually real-time.

The apparatus of the present invention allows users to store cut-off dates as a “snap shot” in order to track project and schedule performance over time, providing users with the ability to quickly and easily see trends and apply leading edge indicators to run projections and perform analysis. Users are able to track trends and changes against multiple baselines, allowing users to automatically note changes and measure the adoption of alternative baselines that may involve an anticipated contract modification, or adoption of an alternative plan based on the risk that their projects are experiencing to date.

The apparatus of the present invention allows users to produce time-phased S-Curves showing percentage of total scope planned, earned, and spent, as well as spreads against early and late planned dates. This information is shared across a project team involving different companies and subcontractors, thereby eliminating data sensitivity issues. S-curves are used for graphic display of cumulative costs, labor hours, percentage of work, or other quantities, plotted against time. They are typically used to depict Planned Value, Earned Value, and Actual Cost of project work.

For detailed analytics and reporting, the apparatus of the present invention provides users with the ability to show early and late start/finish curves in the same histogram with the periodic numbers in a grid below the time-phased trending chart. Users also annotate histograms to highlight important past and future events in a project timeline.

Certain proprietary project scheduling programs cannot be transformed to UN/CEFACT XML using direct field mapping because the information will not be presented in a standardized or expected format. Data from proprietary project scheduling programs that cannot be converted to UN/CEFACT XML through direct field mapping can be first entered into a Microsoft Excel spreadsheet template that is part of the apparatus of the present invention. Once the data is contained in the Microsoft Excel file template, direct field mapping is used to convert the data into UN/CEFACT XML. As with the other project scheduling tools, once the data is in UN/CEFACT XML, it can be imported into the database of the present invention where analytics are run.

The analytics assist users by providing visual cues and alerts for identifying any errors or performance outliers in project data coming from underlying systems. Conditional formatting trend indicators (leading-edge indicators), outliers, sorting, filtering, and pre-configured alerts based on user customized configurations of quality checks on the data and based on user customized configurations of quality checks on the data are all used.

FIG. 1 is a flow chart illustrating a process of transforming project source data into standard UN/CEFACT XML format file, importing the data into the database, and running analytics on the data contained in the database. As shown in FIG. 1, the process 10 includes the following steps:

In step 11, the data exists in a proprietary source format. The proprietary source format is then converted to standardized UN/CEFACT XML format files in step 12. In step 13, the user has the option of importing the data into the database after the data is converted to UN/CEFACT XML. If the user chooses not to import the data into the database, the project data remains in standard UN/CEFACT XML format files, step 14. In step 15, the user has chosen to import the standard UN/CEFACT XML format files into the database. When the user imports the standard UN/CEFACT XML format files, the current project data will be appended to the existing project data if the project currently exists in the database, otherwise, a new project will automatically be created. Procedures are also run to normalize the data and generate a valid replication of the schedule data in a normalized state. In step 16, the user is given the option of performing analytics on the data. In step 17, the user chooses not to perform analytics and the data remains in the database. In step 18, the user chooses to perform analytics on the data. The user selects the desired workspace and project where analytical, reporting, and business intelligence information is automatically generated for the selected project determined by the analysis capabilities setup in the workspace containing the data and workspaces are automatically generated for analytical, reporting, and business intelligence information on the selected project.

FIGS. 2-4 illustrate different examples of the present invention, specifically, how different source project files are converted to UN/CEFACT XML.

FIG. 2 is a flow chart illustrating a process of transforming a source Microsoft Project file to standard UN/CEFACT XML format file. As shown in FIG. 2, the process 20 includes the following steps:

In step 22, the user launches the program. In step 23, the user selects source .mpp source file to convert to standardized UN/CEFACT XML format file. In step 24, the user inputs additional custom fields to add to the UN/CEFACT XML output file, if desired. In step 25, the user maps additional fields from source .mpp file to destination XML file, if desired. The source proprietary .mpp file comprises additional fields as inputted by the user. If custom information is entered into the additional fields in Microsoft Project, the user manually maps those additional fields to the UN/CEFACT XML file. In step 26, the user specifies the output filename and the XML file is generated using UN/CEFACT XML schema. In step 27, the user saves the UN/CEFACT XML file.

FIG. 3 is a flow chart illustrating a process of transforming Oracle Primavera P6 or Deltek Open Plan Professional project data to standard UN/CEFACT XML format file. As shown in FIG. 3, the process 30 includes the following steps:

In step 32, the user launches the program. In step 33, the user connects to Oracle Primavera P6 or Deltek Open Plan Professional database, or selects proprietary export file to convert to standardized UN/CEFACT XML format file. In step 34, the user inputs additional custom fields to add to the UN/CEFACT XML output file, if desired. In step 35, the user maps additional fields from source database or file to destination XML file, if desired. In step 36, the user specifies the output filename and the XML file is generated using UN/CEFACT XML schema. In step 37, the user saves the UN/CEFACT XML file.

FIG. 4 is a flow chart illustrating a process of transforming project source data of a legacy or uncommonly used scheduling program where a Microsoft Excel template is used as an intermediate process to normalize the schedule data to be mapped to standard UN/CEFACT XML format file. As shown in FIG. 4, the process 40 includes the following steps:

In step 42, the user maps or enters project data into the Microsoft Excel template of the present invention. In step 43, the user launches the program. In step 44, the user selects source Microsoft Excel file to convert to standardized UN/CEFACT XML format file. In step 45, the user specifies the output filename and XML file is generated using UN/CEFACT XML schema. In step 46, the user saves the UN/CEFACT XML file.

Using the Microsoft Excel template allows for any project data to be converted into UN/CEFACT XML. Project items that are handwritten, contained in Microsoft Word documents, contained in unsupported formats, etc., are transformed in the apparatus of the present invention to UN/CEFACT XML.

FIG. 5 is a flow chart illustrating a process of importing standard UN/CEFACT XML format file into database and associating it with a specific project. As shown in FIG. 5, the process 50 includes the following steps:

In step 51, the user launches the program. In step 52, the user selects the source file in UN/CEFACT XML format. In step 53, the user selects the schema type. Under the UN/CEFACT XML standard, there are 3 standard schemas within that UN/CEFACT “umbrella.” The three schemas are: cost schema, schedule schema, and historical and time phased cost. In step 54, data from the UN/CEFACT XML source file is imported into the database and associated with existing or newly created project. The apparatus of the present invention automatically associates each UN/CEFACT XML file with the appropriate project. In step 55, procedures are automatically run to normalize the data and generate a valid replication of the schedule data in a normalized state to allow for analytics to be run.

FIG. 6 is a flow chart illustrating a process of running analytics on a project containing standard UN/CEFACT XML format file(s). As shown in FIG. 6, the process 60 includes the following steps:

In step 61, the user launches the program. In step 62, the user selects the project to run analytics on from the database. In step 63, workspaces are automatically generated with pre-defined fields and graphs. In step 64, the user is able to run custom analytics in any workspace.

An advantage of the apparatus of the present invention is that it allows for project scheduling data in any format to be converted to UN/CEFACT XML. Depending on the source format, the process in FIGS. 2-4 is used to convert the file. Once the file is converted to UN/CEFACT XML, it is imported into the database where the data is normalized to allow for analytics to be run. Once all data is in the database and the user selects the project, workspaces are automatically generated. Once generated, the user runs custom analytics in any of the workspaces.

While the present invention has been described in conjunction with a specific best mode, it is to be understood that many alternatives, modifications, and variations will be apparent to those skilled in the art in light of the foregoing description. Accordingly, it is intended to embrace all such alternatives, modifications, and variations that fall within the scope of the included claims. All matters previously set forth herein or shown in the accompanying drawings are to be interpreted in an illustrative and non-limiting sense.

What is claimed is:

1. A method for analyzing data comprising:
converting project scheduling data to UN/CEFACT XML;
importing the UN/CEFACT XML data into a database;
normalizing the data;
generating a valid replication of the schedule data in a normalized state; and
calculating metrics.

2. The method for analyzing data of claim 1 further comprising converting proprietary project scheduling data to UN/CEFACT XML.

3. The method for analyzing data of claim 1 further comprising drawing data contained in multiple UN/CEFACT XML data files contained in the database.

4. The method for analyzing data of claim 1 further comprising containing other UN/CEFACT XML data obtained by transforming data from other project scheduling software.

3. The method for analyzing data of claim 1 further comprising modeling project scheduling data from proprietary project scheduling software.

4. The method for analyzing data of claim 1 further comprising directly converting the data by direct field mapping into UN/CEFACT XML.

5. The method for analyzing data of claim 1 further comprising calculating user-defined metrics.

6. The method for analyzing data of claim 1 further comprising calculating pre-determined metrics.
